(19) United States
(12) Patent Application Publication
(10) Pub. No.: US 2005/0032953 A1
(43) Pub. Date: Feb. 10, 2005

(54) Mix free paint composition and method of production thereof

(76) Inventor: Joseph Kaltoum, St. Marys (AU)

Correspondence Address: Thomas M Galgano;Galgano & Burke, Suite 135, 300 Rabro Drive, Hauppauge, NY, 11788, US

(21) Appl. No.: 10/490,521

(22) PCT Filed: Sep. 24, 2002
(86) PCT No.: PCT/AU02/01307

(30) Foreign Application Priority Data
Sep. 24, 2001 (AU) PR 7859

(51) Int. Cl. C08K 5/10; C08K 5/07; C08K 3/02; C08K 5/05; C08K 5/04; C08K 5/02; C08K 5/01

(52) U.S. Cl. 524/315; 524/317; 524/360; 524/361; 524/363; 524/364; 524/385

(57) ABSTRACT

A liquid paint composition including a base coat having ingredients which remain mutually mixed; wherein, the paint once prepared, does not require mixing prior to use.

### BACKGROUND

The present invention relates to coating and paint compositions and more particularly relates to a coating composition suitable for use in the refinish and general paints sector which does not require mixing prior to use.

### PRIOR ART

There are in existence a variety of paints, paint compositions and automotive paints. Examples of solvent based coating compositions are disclosed in U.S. Pat. Nos. 4,888,372 and 4,551,492 which are incorporated by reference herein. The compositions disclosed therein require mixing before use. The known paints typically require mixing of the constituents prior to their application. Most paints are manufactured from a number of constituents which must be blended or mixed before use. The mixing also ensures colour integrity but means that a user must mix the paint each time it is used. Paint mixing usually requires use of mixing equipment such as a mixing machine or in smaller applications a paddle or mixing stick to ensure blending of all ingredients and to achieve the required colour shade. This processing especially when paints are required in high volumes, involves increased labour, energy and equipment costs for users. The known paint mixes necessitate use of tints which require positive mixing to achieve predetermined colours. Some automotive paints include metallic components which are relatively heavy and must be mixed with a special purpose mixing machine. Known paints if left for a period of time tend to settle in their container. The heavier constituents migrate to the bottom of the container causing sedimentation. To use the paint, the contents must be re mixed after sedimentation to ensure that the heavier contents are evenly distributed throughout the paint mix.

In the Automotive paint and refinish market, a number of different paints are manufactured for a variety of purposes and to meet consumer needs. The known paints generally comprise pigments including extenders, resins or binders, solvents and additives. Each of these groups contains a broad range of different products whose proportions may be altered to provide different properties. By way of example, the pigments include extenders may provide a range of properties including colour, causing different visual effects, gloss, corrosion resistance, film build, sandability.

One particular property which is extremely important to the Automotive and refinish market is colour and the visual effects that can be achieved with some pigments. The colour and visual effects required of the market can be achieved with a number of different paints. One such paint system is known as a clear over basecoat (COB) system. This involves applying the basecoat which contains the appropriate pigments and extenders to achieve the required colour and effects to a surface such as the body of a car, truck etc followed by a coat of clear paint.

The basecoat part of the system normally consists of a number of individual tinters or primary colours which, when mixed together gives the finished colour. According to known methodology the customer is provided with a set of basecoat tinters and a set of formulae which contain the information necessary for the customer to mix the tinters together to accurately match a known colour standard. Accurate colour matching is essential and to achieve this consumers must have accurate colour formulae and colour stable tinters.

The prior art products suffer from a number of problems that decrease colour stability over time. One problem is known as phasing wherein a separation of pigment and/or extenders from the remaining constituents of the paint causes a clear layer to appear within the paint container. Another problem is settling wherein there is a separation of pigment/extenders from the remaining constituents causing a layer of pigment/extender to form on the bottom of the container. The layer can be either soft or hard and may or may not be associated with phasing. Known basecoat tinters on average contain a higher concentration of pigments and extenders in comparison to other paints. Some of the known paints which use pigments to produce the colours and effects required such as metallics and pearlescents have a high specific gravity. The combination of high level of pigment and high specific gravity can cause both settling and phasing to occur within a very short period of time. The settling and phasing has to be minimised or eliminated to avoid any problems with colour stability. According to known methodology, settling and phasing is minimised by siring the contents of the paint container either by hand or using some form of mechanical device, such as a large bank of stirrers, one for each tinter, which are designed to agitate or stir each container on a regular basis to maintain its uniformity. Such machinery can be large noisy and expensive to buy and run particularly when the number of tinters available is up to but could exceed 120. Also there is a prospect of mechanical failure and thus poor colour stability. The mechanical stirrers according to one version comprise a motor driven chain which has links along its length which engage a stirrer on each paint container. There could be as many as 200 or more paint containers which may be stirred at once as the drive chain is driven along each line of paint containers engaging separate mixers. This arrangement is highly sophisticated mechanically and therefore requires a high level of maintenance. Accordingly, stockists who must buy paint in large quantities to ensure that customers have a wide colour choice particularly for matching existing colours in panel beating for instance, must acquire expensive mixing equipment to ensure the full stock of paints are periodically mixed to avoid the problems of settling and phasing describe earlier. There is a need to provide a paint composition which does not require mixing prior to use and which will stay mixed irrespective of shelf life.

### INVENTION

The present invention seeks to avoid the disadvantages of prior art paint compositions and methods of paint production and distribution by providing an improved industrial paint which can be applied direct from its container without pre mixing and which maintains uniformity irrespective of shelf life. More particularly, the present invention provides a paint composition which does not require mixing immediately before application to a substrate. The invention was developed to overcome problems of the prior art and to provide an economic alternative to the known paints and particularly automotive paints.

The paint compound according to the invention enables the elimination of large mixing machinery and associated stirrers. The paint does not suffer from sedimentation or unwanted upper or lower level phasing. It also allows reduction in costs and labour which would otherwise be spent mixing the paint.

In its broadest from the present invention comprises:
a paint composition including a base coat having constituents which remain mutually mixed; wherein, the paint does not require mixing prior to use; irrespective of the shelf life of the paint. According to one embodiment the paint composition is employed as an automotive paint.

In another broad form the present invention comprises; an automotive paint composition which comprises at least one base coat tinter wherein the base coat tinters have properties which preclude the need to stir said composition and wherein, the tinters properties prevent settling and phasing for the entire time of a predetermined shelf life.

In another broad form of the method aspect the present invention comprises; a method of preparing an automotive paint which does not require mixing before use, the method comprising the steps of:
a) selecting paint ingredients in a combination and physical property which results in a compound which does not require pre mixing prior to application;
b) applying tint to colour the compound;
c) thinning said compound prior to application.

In another broad form the present invention comprises: a paint composition which once prepared does not require mixing prior to application, wherein the composition comprises the following ingredients:
Acrylic Resin
Modified polyester resin
Cellulose Acetate Butyrate
Ethelene Vinayl Acetate Copolymer
Cyclohexanone
1-Methoxy-2-Propyl Acetate
n-Butyl Acetate
2-Propanone
4-Methyl-2-Pentanone
2-Methyl-1-Propanol
Dimethylbenzene (Mixed Isomers)
Methyl Benzene
Aromatic Hydrocarbons

In another broad form the present invention comprises a low solvent paint compound manufactured from a combination of ingredients wherein no agitation of said compound is required prior to use.

In a further broad form the present invention comprises;
a liquid paint composition including a base coat having ingredients which remain mutually mixed; wherein, the paint once prepared, does not require mixing prior to use.

Preferably, the properties of the paint composition are such that it has a lower volatile organic content thereby reducing the requirement for thinning to achieve a sprayable viscosity. Stirrers are not required with the paint composition as a tinter can be used in the knowledge that the pigment is uniform throughout the container and therefore the made up colour will remain uniform and accurate.

In another broad form according to the method aspect the present invention comprises a method of preparing a paint compound in which the paint does not require mixing prior to application; the method comprising the steps of:
a) selecting the following ingredients and blending said ingredients to form a
paint base compound;
Modified polyester resin
Cellulose Acetate Butyrate
Ethelene Vinayl Acetate Copolymer
Cyclohexanone
1-Methoxy-2-Propyl Acetate
n-Butyl Acetate
2-Propanone
4-Methyl-2-Pentanone
2-Methyl-1-Propanol
Dimethylbenzene (Mixed Isomers)
Methyl Benzene
Aromatic Hydrocarbons
b) applying a tint to said compound and allowing said tint to mix without agitation of said compound;
c) thinning said compound prior to application of said compound to a substrate.

According to a preferred embodiment the method comprises the further step of thinning said compound to a predetermined ratio prior to application of said paint

In another broad form the present invention comprises a method of preparation of a paint compound in which a tint added to said compound does not require mixing into said compound prior to application of said paint to a substrate.

The paint made in accordance with the invention can sit on a shelf indefinitely but will not require re mixing when the contents are to be used.

### DETAILED DESCRIPTION

The present invention will now be described in more detail according to a preferred but non limiting embodiments.

Traditionally in the paint industry, paint products require extensive mixing before application This is the case in both automotive and general paints and is essentially due to the nature of the ingredients used in paints. More particularly, due to the high specific gravity of certain paint ingredients sedimentation is prone to occur in which the ingredients vertically separate. Each time a paint is used it must be mixed and the longer a paint is left unused, the more mixing is required. In automotive metallic paints the problem is particularly pronounced where settlement of metallic flakes occurs. Panel beaters must have expensive mixing equipment to ensure paints are properly mixed prior to application. This equipment is expensive to purchase and install and takes up valuable space in a factory.

Colour matching is an important aspect of automotive painting and this is usually done by computer. The user must according to a predetermined formula according to colour prescription add various tints to a base colour following which these must be mixed. Once the tints have been added, the paint is mixed on the mixing machine until fill mixing has taken place. Each company has different systems of tinting with as many as 120 tinters. If one colour is not mixed, the colour will be wrong. According to the present invention a paint compound is provided in which the tinters are diluted assisting spontaneous mixing and obviating the need for mechanical mixing into a base coat. Panel beaters often have beaters or mixers and high foot print mixing apparatuses which can take up as much space as 5 square meters. The present invention allows such mixing apparatuses to be eliminated as the selected ingredients of the paint compound of the invention including the tints spontaneously mix. The mixing remains even where the paint is allowed to stand for long periods of time on a shelf. The compound is achieved by appropriate selection of the ingredients and the correct blending of these ingredients. The selection of the ingredients and proportions contribute to the avoidance of unwanted settlement of the ingredients which would otherwise necessitate mixing to re establish paint integrity. Advantages of the present invention include: power and energy savings, elimination of labour required in mixing of ingredients, economy, elimination of need to mix tinters and without compromise to mixing accuracy. Further advantages include
i) lower cost outlays for machinery, repairs, thinners and no down time due to mechanical failures.
ii) increased colour accuracy due to improved pigment uniformity;
iii) reduced noise in preparations;
iv) use of less thinners thus a lower level of volatile organic material being released into the atmosphere.

The liquid paint composition includes a base coat having ingredients which remain mutually mixed; wherein, the paint once prepared, does not require mixing prior to use. The composition is preferably solvent based, wherein a clear over base coat includes at least one pigment, {extenders}, at least one resin/binder, additives and at least one solvent. The paint composition which is preferably a base coat tinter further comprises additives include an anti settling agent

Preferably the at least one resin are selected from the following: acrylic Resin and/or Modified polyester resin and/or Cellulose Acetate Butyrate and/or Ethelene Vinayl Acetate Copolymer.

Preferably, at least one solvent/s are selected from the following: Cyclohexanone and/or 1-Methoxy-2-Propyl Acetate and/or n-Butyl Acetate and/or 2-Propanone and/or 4-Methyl-2-Pentanone and/or 2-Methyl-1-Propanol and further comprises; Dimethylbenzene (xylene) and Methyl Benzene (toluene). The solvents are selected according to prescribed evaporation rates.

The paint composition formed by the ingredients has properties which prevent settling and/or phasing of the ingredients so that the paint can be applied from a container holding the composition without pre mixing before use. Each base coat tinter is a tinter which is capable of mixing with a like base coat tinter according to a predetermined colour formula. The paint composition is according to one embodiment employed as an automotive paint composition; wherein the specific gravity of the base coat tinter falls within the range of 0.8 kg/l-3 kg/l. The viscosity of the composition preferably falls within the range 20-20000 centerpoises and is dictated by solvent selection

According to one embodiment, three solvents are selected with respective fast medium and slow evaporation rates. The liquid paint composition may be formed formed as a base coat tinter by a blend of ingredients selected from the following classes 1, 2 and 3 of ingredients;
Class 1
Acrylic Resin
Modified polyester resin
Cellulose Acetate Butyrate
Ethelene Vinayl Acetate Copolymer
Class 2
Cyclohexanone
1-Methoxy-2-Propyl Acetate
n-Butyl Acetate
2-Propanone
4-Methyl-2-Pentanone
2-Methyl-1-Propanol
Class 3
Dimethylbenzene (Mixed Isomers)
Methyl Benzene;
   wherein, due to the ingredients selected, the composition does not require mixing during its shelf life or just prior to use.

The ingredients of the composition are mixed during preparation of the base coat tinter composition but do not require premixing prior to use of the base coat tinter.

The pigment is uniform throughout the container thereby allowing uniformity of colour. The paint composition comprises selected ingredients imparting a consistency to the paint compound which precludes settlement or phasing of any one or more of the ingredients such that the paint does not require mixing prior to use. The invention will now be described according to a method aspect.

A paint composition prepared according to a method aspect comprises ingredients selected from the following:
Acrylic Resin
Modified polyester resin
Cellulose Acetate Butyrate
Ethelene Vinayl Acetate Copolymer
Cyclohexanone
1-Methoxy-2-Propyl Acetate
n-Butyl Acetate
2-Propanone
4-Methyl-2-Pentanone
2-Methyl-1-Propanol
Dimethylbenzene (Mixed Isomers)
Methyl Benzene.

The composition comprises a base coat tinter wherein the tinter has properties which prevent settling and phasing of the composition for the entire time of a predetermined shelf life of the composition thereby precluding the need to stir the paint composition.

According to one embodiment of the method aspect the composition is prepared according to the following steps:
a) selecting paint ingredients in a combination and physical property which results in a paint compound which does not require pre mixing prior to application;
b) applying tint to colour the compound without mixing;
c) thinning said compound prior to application.

There is provided, a method of preparing a paint composition in which the paint does not require mixing prior to application; wherein the method comprises the steps of:
a) selecting the following ingredients and blending said ingredients to form paint base composition;
Modified polyester resin
Cellulose Acetate Butyrate
Ethelene Vinayl Acetate Copolymer
Cyclohexanone
1-Methoxy-2-Propyl Acetate
n-Butyl Acetate
2-Propanone
4-Methyl-2-Pentanone
2-Methyl-1-Propanol
Dimethylbenzene (Mixed Isomers)
Methyl Benzene
Aromatic Hydrocarbons
b) thinning said compound to a predetermined ratio prior to application of said compound to a substrate.

The invention is particularly suitable for the Auto refinish applications, wherein at least 60,000 colour combinations are available to the consumer. Base coat tinters are mixed to formal final prescription colour. The invention is achieved by subtle adjustments of one or more of resins solvents and additives herein described. The composition which is free from phasing is achieved via the formula and the manner in which the selected ingredients are blended together.

Mixing takes place in four main stages. In the first stage a colourant and pigment are dispersed in a universal solution of a predetermined volume. In the second stage, a resin binder and additive solution are included and the composition so formed is mixed to a toothpaste consistency. The particulate level is about 10 microns. The pigment is dispersed at about 10 microns. Stage 1 is the colourant stage and the result of stage 2 is known as the base. In the third stage a wax polymer is separately dissolved from solid pellets at about 120 degrees C. and this is precipitated and added to the solution created by stage 2. In a further fourth stage cellulose acetate is dissolved separately and added to the stage 2 solution. The stage 1 solution (colourant) is added to the stage 2 solution (base coat). The mix free paint is achieved by subtle mixing of the additives resins and solvents in predetermined quantities as previously described. Solvent viscosity levels are carefully predetermined to avoid phasing. Too much solvent will cause phasing.

Ideally the composition will include a first solvent with a first evaporation rate, a second solvent with a slower evaporation than the first solvent and a third solvent with an evaporation rate slower that the second solvent to prevent seeding. According to the prior art compositions it was necessary to mix at least three times a day to avoid unwanted phasing and settlement. The present invention overcomes this problem.

It will be recognised by persons skilled in the art that numerous variations and modifications may be made to the invention as broadly described without departing from the spirit and scope of the invention.

1. A liquid paint composition including a base coat having ingredients which remain mutually mixed; wherein, the paint once prepared, does not require mixing prior to use.

2. A paint composition according to claim 1 wherein the composition is solvent based.

3. A paint composition according to claim 2 wherein, the composition is a clear over base coat includes at least one pigment, (extenders), at least one resin/binder and at least one solvent.

4. A paint composition according to claim 3 further comprising additives.

5. A paint composition according to claim 4 wherein said additives include an anti settling agent.

6. A paint composition according to claim 5 wherein, the paint is a base coat tinter.

7. A paint composition according to claim 5 wherein the at least one resin are selected from the following:
acrylic Resin and/or Modified polyester resin and/or Cellulose Acetate Butyrate and/or Ethelene Vinayl Acetate Copolymer.

8. A paint composition according to claim 5 wherein the at least one solvents are selected from the following:
Cyclohexanone and/or 1-Methoxy-2-Propyl Acetate and/or n-Butyl Acetate and/or 2-Propanone and/or 4-Methyl-2-Pentanone and/or 2-Methyl-1-Propanol.

9. A paint composition according to claim 5 further comprising Demethylbenzene (xylene) and MethylBenzene (toluene).

10. A paint composition according to claim 1 wherein the composition formed by the ingredients has properties which prevent settling and/or phasing of the ingredients so that the paint can be applied from a container holding the composition without pre mixing before use.

11. A paint composition according to claim 10 wherein the base coat is a tinter which is capable of mixing with a like base coat tinter according to a predetermined colour formula.

12. A paint composition according to claim 11 wherein the base coat tinter is employed as an automotive paint composition.

13. A paint composition according to claim 12 wherein the solvents are selected according to prescribed evaporation rates.

14. A paint composition according to claim 13 wherein the specific gravity of the base coat tinter falls within the range of 0.8 kg/l-3 kg/l.

15. A paint composition according to claim 14 wherein the viscosity of the composition falls within the range 20-20000 centerpoises.

16. A paint composition according to claim 15 wherein the viscosity of the composition is dictated by solvent selection.

17. A paint composition according to claim 16 wherein, three solvents are selected with respective fast, medium and slow evaporation rates.

18. A liquid paint composition formed as a base coat tinter by a blend of ingredients selected from the following classes 1, 2 and 3 of ingredients;
Class 1
Acrylic Resin
Modified polyester resin
Cellulose Acetate Butyrate
Ethelene Vinayl Acetate Copolymer
Class 2
Cyclohexanone
1-Methoxy-2-Propyl Acetate
n-Butyl Acetate
2-Propanone
4-Methyl-2-Pentanone
2-Methyl-1-Propanol
Class 3
Dimethylbenzene (Mixed Isomers)
Methyl Benzene;
wherein, due to the ingredients selected, the composition does not require mixing during its shelf life or just prior to use.

19. A composition according to claim 18 wherein the ingredients are mixed during preparation of the base coat tinter composition but do not require premixing prior to use of the base coat tinter.

20. A paint composition according to claim 19 wherein the pigment is uniform throughout the container thereby allowing uniformity of colour.

21. A paint composition comprising selected ingredients imparting a consistency to the paint compound which precludes settlement or phasing of any one or more of the ingredients such that the paint does not require mixing prior to use.

22. A paint composition according to claim 21 wherein ingredients for the composition are selected from the following:
Acrylic Resin
Modified polyester resin
Cellulose Acetate Butyrate
Ethelene Vinayl Acetate Copolymer
Cyclohexanone
1-Methoxy-2-Propyl Acetate
n-Butyl Acetate
2-Propanone
4-Methyl-2-Pentanone
2-Methyl-1-Propanol
Dimethylbenzene (Mixed Isomers)
Methyl Benzene
the composition comprises a base coat tinter wherein the tinter has properties which prevent settling and phasing of the for the entire time of a predetermined shelf life of the composition thereby precluding the need to stir the paint composition.

23. A method according to claim 22 wherein the composition is an automotive paint.

24. A method of preparing an automotive paint, the method comprising the steps of:
a) selecting paint ingredients in a combination and physical property which results in a paint compound which does not require pre mixing prior to application;
b) applying tint to colour the compound without mixing;
c) thinning said compound prior to application.

25. A method of preparing a paint composition in which the paint does not require mixing prior to application; the method comprising the steps of:
a) selecting the following ingredients and blending said ingredients to form paint base composition;
Modified polyester resin
Cellulose Acetate Butyrate
Ethelene Vinayl Acetate Copolymer
Cyclohexanone
